(19) United States
(12) Patent Application Publication
(10) Pub. No.: US 2021/0039657 A1
(43) Pub. Date: Feb. 11, 2021

(54) EVALUATION METHOD FOR DRIVING SERVICE AND EVALUATION DEVICE FOR DRIVING SERVICE, APPARATUS AND STORAGE MEDIUM

(71) Applicants: BEIJING BOE DISPLAY TECHNOLOGY CO., LTD., Beijing (CN); BOE TECHNOLOGY GROUP CO., LTD., Beijing (CN)

(72) Inventors: Yangchen GUO, Beijing (CN); Dong WANG, Beijing (CN); Jingjing JIANG, Beijing (CN)

(21) Appl. No.: 16/966,811

(22) PCT Filed: Jan. 2, 2019
(86) PCT No.: PCT/CN2019/070092

§ 371 Date: Jul. 31, 2020

(30) Foreign Application Priority Data
Mar. 30, 2018 (CN) 201810293694.0

(51) Int. Cl. B60W 40/09; G01C 21/34; G01C 21/36; G06Q 30/02; G06Q 10/04

(52) U.S. Cl. CPC B60W 40/09; G01C 21/3438; B60W 2556/10; G06Q 30/0282; G06Q 10/04; G01C 21/3617

(57) ABSTRACT

The present disclosure provides an evaluation method for driving service and an evaluation device for driving service, an apparatus and a storage medium. The method includes the following steps: collecting driving behavior information and travel information; assessing the driving behavior information and the travel information according to a preconfigured driving assessment rule to obtain a driving assessment result; and generating an evaluation result according to the driving assessment result.

### TECHNICAL FIELD

The present disclosure relates to, but is not limited to, the technical field of driving service, and in particular relates to an evaluation method for driving service and an evaluation device for driving service, an apparatus and a storage medium.

### BACKGROUND

Currently, in a solution for online car-hailing in the market, an objective evaluation method for driving service from a driver is lacked.

Currently, evaluation of the driver is generally determined only by a star scoring performed by a passenger. However, there is no restriction mechanism on how the passenger performs the star scoring, and it is generally difficult to provide the restriction mechanism. Therefore, currently, an objective evaluation for driving service from a driver cannot be realized.

In addition, when a passenger is in a dispute with a driver, it is sometimes necessary to verify whether there is a malicious evaluation for the scoring performed by the passenger. Therefore, a cost of an operator could be increased and there may be a case where it is not verifiable.

### SUMMARY

In a first aspect, an embodiment of the present disclosure provides an evaluation method for driving service, including steps of: collecting driving behavior information and travel information; assessing the driving behavior information and the travel information according to a preconfigured driving assessment rule to obtain a driving assessment result; and generating an evaluation result according to the driving assessment result.

Optionally, the step of collecting driving behavior information and travel information includes a step of: recording a travel speed curve, and marking key positions on the travel speed curve to assess a driving behavior of each of the key positions.

Optionally, the step of assessing the driving behavior information and the travel information according to a preconfigured driving assessment rule to obtain a driving assessment result further includes a step of: performing an assessment for a route according to route planning information and a driving route.

Optionally, the step of collecting driving behavior information and travel information further includes at least one of steps of: generating a plurality of planned routes and sending the plurality of planned routes to a passenger side for selection and generation of route planning information, and receiving the route planning information returned from the passenger side; and generating an optimal planned route, sending the optimal planned route to the passenger side for confirmation or modification and generation of route planning information, and receiving the route planning information returned from the passenger side.

Optionally, the method further includes steps of: receiving passenger evaluation information; assessing the passenger evaluation information according to a preconfigured service assessment rule to obtain a service assessment result; and the step of generating an evaluation result according to the driving assessment result includes a step of: generating the evaluation result according to the driving assessment result and the service assessment result.

Optionally, the method further includes a step of collecting monitoring information; the step of assessing the passenger evaluation information according to a preconfigured service assessment rule to obtain a service assessment result further includes a step of: performing an assessment for service attitude and quality according to the monitoring information and a preconfigured service assessment rule.

Optionally, the method further includes collecting demand supply information and receiving demand feedback information; the step of assessing the passenger evaluation information according to a preconfigured service assessment rule to obtain a service assessment result further includes steps of: assessing the demand supply information and the demand feedback information according to a preconfigured service assessment rule.

Optionally, the method further includes steps of: generating estimated time of a pickup and collecting actually consumed time of the pickup; the step of assessing the passenger evaluation information according to a preconfigured service assessment rule to obtain a service assessment result further includes a step of: assessing the estimated time of the pickup and the actually consumed time of the pickup according to a preconfigured service assessment rule.

Optionally, the driving behavior information includes at least one of: a vehicle speed on each road section of a travel, an acceleration on each road section of the travel, the number of lane changes, a frequency of lane changes, the number of whistles, a frequency of whistles; the travel information includes at least one of: speed limit information on each road section of the travel, road condition congestion information on each road section of the travel, place information of prompting deceleration, and curve section information.

In a second aspect, an embodiment of the present disclosure provides an evaluation device for driving service including a collection component, a driving assessment component, and an evaluation component. The collection component is configured to collect driving behavior information and travel information; the driving assessment component is configured to assess the driving behavior information and the travel information according to a preconfigured driving assessment rule to obtain a driving assessment result; the evaluation component is configured to generate an evaluation result according to the driving assessment result and the service assessment result.

Optionally, the collection component includes: a marking subcomponent configured to record a travel speed curve and perform marking key positions on the travel speed curve, to assess a driving behavior of each of the key positions.

Optionally, the driving assessment component includes: a route assessment subcomponent configured to perform a route assessment based on the route planning information and a driving route; the collection component includes at least one of a first route planning subcomponent and a second route planning subcomponent; the first route planning subcomponent is configured to generate a plurality of planned routes, send the plurality of planned routes to a passenger side for selection and generation of route planning information, and receive the route planning information returned from the passenger side; the second route planning subcomponent is configured to generate an optimal planned route, send the optimal planned route to a passenger side for confirmation or modification and generation of route planning information, and receive the route planning information returned from the passenger side.

In a third aspect, an embodiment of the present disclosure also provides an electronic apparatus including: one or more processors; a memory for storing one or more programs, the one or more programs, when executed by the one or more processors, cause the one or more processors to perform the evaluation method for driving service provided according to embodiments of the present disclosure.

In a fourth aspect, an embodiment of the present disclosure also provides a storage medium storing computer programs which cause the computer to perform the method of evaluating driving service provided according to embodiments of the present disclosure.

### BRIEF DESCRIPTION OF DRAWINGS

Other features, objects and advantages of the present disclosure will become more apparent upon reading the detailed description of non-limiting embodiments made with reference to the following drawings:

FIG. 1 is a flowchart of an evaluation method for driving service according to an embodiment of the present disclosure.

FIG. 2 is a schematic view of marks of a driving travel according to an embodiment of the present disclosure.

FIG. 3 is a flowchart of an evaluation method for driving service according to another embodiment of the present disclosure.

FIG. 4 is a flowchart of an evaluation method for driving service according to another embodiment of the present disclosure.

FIG. 5 is a flowchart of an evaluation method for driving service according to another embodiment of the present disclosure.

FIG. 6 is a flowchart of an evaluation method for driving service according to another embodiment of the present disclosure.

FIG. 7 is a flowchart of an evaluation method for driving service according to another embodiment of the present disclosure.

FIG. 8 is a schematic structural diagram of an evaluation device for driving service according to an embodiment of the present disclosure.

FIG. 9 is a schematic structural diagram of an evaluation device for driving service according to another embodiment of the present disclosure.

FIG. 10 is a schematic structural diagram of an evaluation device for driving service according to another embodiment of the present disclosure.

FIG. 11 is a schematic structural diagram of an apparatus according to an embodiment of the present disclosure.

### DETAIL DESCRIPTION OF EMBODIMENTS

The present disclosure is described in further detail below in conjunction with the accompanying drawings and embodiments. It is to be understood that the specific embodiments described herein are merely illustrative of the relevant disclosure and are not limiting the disclosure. It should be further noted that, for a convenience of description, only the portions relevant to the disclosure are shown in the drawings.

It should be noted that, in the present disclosure, the embodiments and the features of the embodiments may be combined with each other without conflicting with each other. The present disclosure will be described in detail below with reference to the accompanying drawings in conjunction with embodiments.

In general, a driving navigation build in a car-hailing APP only provides information such as planning and guiding routes, estimating travel time, and prompting congestion and traffic accidents, but cannot evaluate a service quality of a driving travel by using such information.

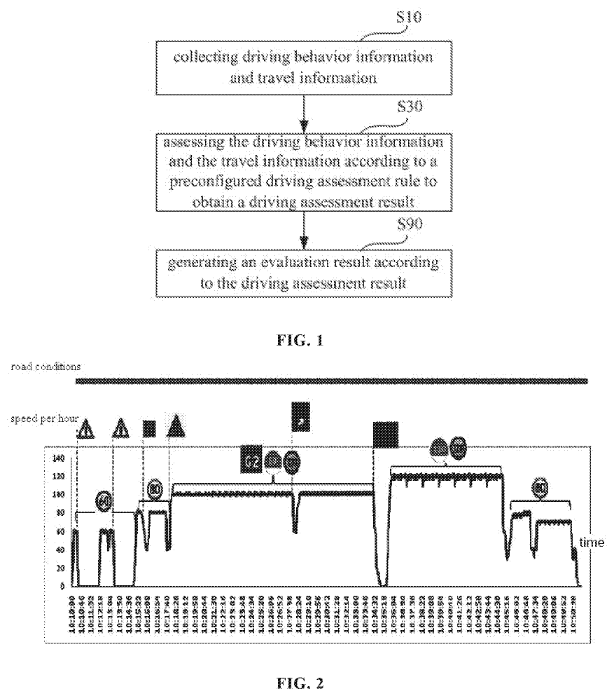

FIG. 1 is a flowchart of an evaluation method for driving service according to an embodiment of the present disclosure.

As shown in FIG. 1, in the present embodiment, the present disclosure provides an evaluation method for driving service, including:

S10: collecting driving behavior information and travel information;

S30: assessing the driving behavior information and the travel information according to a preconfigured driving assessment rule, to obtain a driving assessment result; and

S90: generating an evaluation result according to the driving assessment result.

Specifically, in the present embodiment, the evaluation method for driving service provided by the present disclosure is applied to a smart phone of a driver, and is executed by an application installed in the smart phone when running; in other embodiments, the method may also be applied to other intelligent terminals such as a tablet computer, a notebook computer and an intelligent wearable apparatus; in yet another embodiment, it may also be configured to be performed by an on-vehicle system; in still other embodiments, it may also be configured to be performed by an evaluation device for driving service dedicated to an evaluation for driving service. It will be appreciated by one of ordinary skill in the art that a same technical effect may be achieved as long as the device for performing the method is used as a communication connection among a driver side, a collection device and a passenger side. Furthermore, the above method may also be configured to be performed in a passenger side, as will be appreciated by one of ordinary skill in the art. For example, the passenger side may include, but is not limited to, a smart terminal such as a smart phone of the passenger, or an evaluation device for driving service specially configured for the passenger.

In step S10, the driving behavior information and the travel information may include: directly collected physical information such as information collected by an on-vehicle apparatus during driving, information acquired from an on-vehicle system, information acquired from a remote server, information acquired through the Internet, and the like. The driving behavior information and the travel information may also include another part of information that cannot be directly collected and needs to be obtained by performing data analysis on the acquired physical information. In this embodiment, the driving behavior information includes information such as a vehicle speed on each road section of the travel, an acceleration on each road section of the travel, the number of times of lane change, a frequency of lane change, the number of times of whistle, a frequency of whistle; the travel information includes information such as speed limit information on each road section of the travel, road condition congestion information on each road section of the travel, place information of prompting deceleration, curve section information and the like. The travel usually includes a plurality of road sections with different speed limit requirements and different road conditions, so that collecting and recording of information are respectively performed on each road section, or information is collected in the whole travel and is recorded or marked in respective sub-sections. The information may be acquired through communication with an on-vehicle system (for example, vehicle speed, acceleration, the number of times of whistle and the like), may be directly collected by an app or identified after collecting the information (for example, the transverse position of the vehicle is recorded to identify the number of times of lane change, identify a frequency of lane change in combination with a time axis, sound information is collected to identify the number of times of whistle, identify a frequency of the whistle in combination with a time axis and the like), and may be acquired through image collection by an on-vehicle apparatus or a device at the passenger side (for example, images of signposts, notice boards and the like are collected and identified). In further embodiments, the driving behavior information and the travel information may be further configured to include any one or more of the above information according to different assessment rules and requirements, respectively, and may further include other information related to driving behaviors and data information related to the travel.

Collection of a part of the above information is described below with reference to FIG. 2. FIG. 2 is a schematic view of marks of a driving travel in an embodiment of the present disclosure. As shown in FIG. 2, a travel speed curve of vehicle driving is recorded with time as a horizontal axis and speed as a vertical axis, and key positions of the curve are marked according to various collected travel information. Here, the key positions specifically include intersections, traffic lights, sharp turns, consecutive curves, train tracks, pedestrian paths, tunnels, low-speed-limit sections, mountain roads, accident-prone sections, villages, front schools, and the like. The key positions are configured by a remote background server side in advance according to the latest actual road condition so as to ensure that all key positions in the driving travel are contained as far as possible. Through the marking of the key positions, the driving behaviors of the vehicle at the key positions may be collected, such as the acceleration of the vehicle when the vehicle passes through consecutive curves (for evaluating whether the driving is smooth), the speed of the vehicle when the vehicle passes through a low-speed-limit section (for evaluating whether poor driving behaviors exist), and the like.

As shown in FIG. 2, the above curve may also be marked by real-time road condition information acquired during driving (or historical road condition information acquired after driving is completed) so as to accurately analyze driving behaviors of each road section. For example, on a non-congested normal traffic section, an excessively low vehicle speed belongs to a poor driving behavior, while on a congested section, an excessively low vehicle speed belongs to a normal driving behavior.

During the driving, the passenger side may also display the driving speed of the vehicle in real time according to positioning of the vehicle. In addition, information acquired in real time, such as acceleration, may be displayed in real time.

In step S30, the collected driving behavior information and the travel information are assessed according to a preconfigured driving assessment rule, and finally a score is obtained as a driving assessment result. In more embodiments, other assessment results commonly used in the field, such as star scoring, may be used as driving assessment results. In this embodiment, the driving assessment rule may include:

In a case of driving at a speed lower than a lowest speed limit of the road section above a preset distance (for example, 500 meters), the score is deducted according to a preconfigured rule;

In a case of driving at a speed higher than a highest speed limit of the road section above a preset distance (for example, 500 meters), the score is deducted according to a preconfigured rule;

In a case where any deceleration behavior is not taken within a preset distance (for example, 100 meters) before a target prompted by the key positions to a prompted target road section, the score is deducted according to a preconfigured rule;

In a case where an instantaneous acceleration is too high (a rapid acceleration or a rapid deceleration), the score is deducted according to a preconfigured rule;

In a case where the speed at the curve is too high, the score is deducted according to a preconfigured rule;

In a case where the frequency of lane change is too high, the score is deducted according to a preconfigured rule;

In a case where the frequency of whistle is too high, the score is deducted according to a preconfigured rule.

Here, each of above rules may be divided into a detailed rule with different levels in which the score is deducted in each level.

The above driving assessment rule is only an example, and in further embodiments, the driving assessment rule may be configured as any one or more of the above rules according to actual requirements, and may further include other driving assessment rules understood by one of ordinary skill in the art, so long as the driving assessment rule reasonably assesses driving services provided by the driver for the passenger based on the driving behavior information and the travel information collected in step S10, the same technical effect may be achieved. In addition, the driving assessment rule adopts an assessment mode of deducting scores from total scores. In addition, the driving assessment rule may be configured to adopt an assessment mode of scoring good driving service behaviors, and the same technical effect may be achieved.

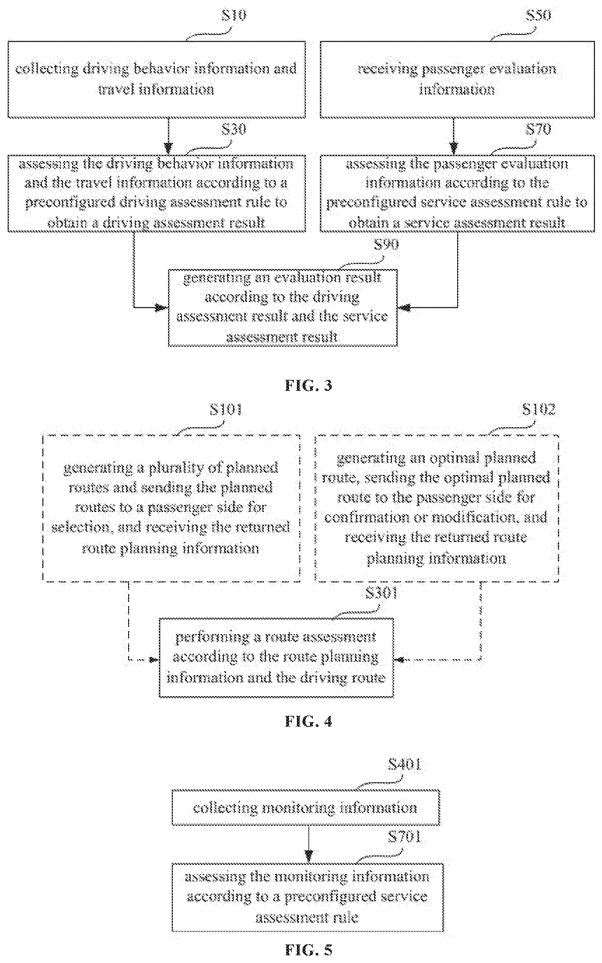

In step S90, evaluation results in various text, graphic, or other forms for presentation may be generated directly according to the driving assessment result generated in step S30, or final evaluation results may be generated by further combining with more assessment result information obtained in different assessment modes. FIGS. 3-7 are flow charts illustrating obtaining assessment result information by different assessment modes.

As shown in FIG. 3, in this embodiment, the method further includes:

S50: receiving passenger evaluation information; and

S70: assessing the passenger evaluation information according to the preconfigured service assessment rule, to obtain a service assessment result.

Step S90 includes: generating an evaluation result according to the driving assessment result and the service assessment result.

In step S50, the passenger evaluation information forwarded by the passenger side through a remote service terminal is received. The passenger evaluation information may be configured as star scoring, numerical scoring, character evaluation or voice evaluation, and also may be a combination of any of the above items; may only include an overall evaluation, or also may include a plurality of detailed evaluations.

In step S70, a service assessment is performed according to the passenger evaluation information received in step S50 in combination with the preconfigured service assessment rule, and a score is finally obtained as a driving assessment result. In more embodiments, other assessment results commonly used in the field, such as star scoring, may be used as driving assessment results. If the passenger evaluation information includes star scoring or numerical scoring, the assessment may be directly performed; if the passenger evaluation information only includes character evaluation or voice evaluation, semantic recognition is required to be performed firstly; if the passenger evaluation information is empty and does not include any content, the passenger evaluation information may be configured as a default good evaluation score or other default evaluation score options commonly used in the art. In this embodiment, the service assessment rule may include:

In a case where the passenger evaluates that the cleanliness in the car is low, the score is deducted according to a preconfigured rule;

In a case where the passenger evaluates that the service attitude is poor, the score is deducted according to a preconfigured rule.

Similarly to the driving assessment rule, each of above rules may also be divided into a detailed rule with different levels in which the score is deducted in each level.

The above service assessment rule is only an example, and in further embodiments, the service assessment rule may be configured as any one or more of the above rules according to actual requirements, and may further include other service assessment rules understood by one of ordinary skill in the art, so long as the service assessment rule reasonably assesses driving services provided by the driver for the passenger based on the passenger evaluation information collected in step S50, the same technical effect may be achieved. In addition, the service assessment rule adopts an assessment mode of deducting scores from total scores. In addition, the service assessment rule may be configured to adopt an assessment mode of scoring good driving service, and the same technical effect may be achieved.

In step S90, a fusion calculation is performed on the driving assessment result generated in step S30 and the service assessment result generated in step S70, and specifically, a final evaluation result may be generated by using a direct addition, a weighted calculation, or the like.

After the evaluation result is generated, the evaluation result may be displayed at a driver side and sent to a passenger side for displaying through a remote service terminal. Besides the evaluation result, the displayed content may further include each scoring item and a scoring basis, such as the travel speed graph with several items marked as described above, so that the driver and the passenger may know the origin and basis of the final evaluation result.

In an exemplary embodiment, the driver's average score in the last week, the average score in the last month and the average score of all historical travels may be displayed on the driver's side and the passenger's side respectively, for reference of the driver and the passenger and the operator. The scoring result may be provided for operators to perform appropriate reward and punishment in various modes. For example, if the average score in the last week is lower than 80, the order is stopped for 1 day; if the average score in the last month is higher than 98, cash rewards are given, and the like.

The above-described embodiment objectively evaluates whether the driver provides a good driving service to the passenger during driving by collecting objective driving behavior information and travel information. And a final evaluation result is generated by combining a service assessment result generated according to the passenger evaluation information, so that an objective evaluation for the driving service of a driver is achieved. Thus, an objective basis with lower cost is provided for disputes. It determines whether overspeed exists by analyzing the speed of the vehicle, whether a stable driving service is provided by a driver by analyzing the acceleration, whether a high-quality driving service is provided by analyzing information such as the number of times of lane change and a frequency of lane change, the number of times of whistle and a frequency of whistle and the like, which provides an objective and reliable evaluation basis and mode for the assessment of the driving service.

As shown in FIG. 4, in the present embodiment, step S10 further includes:

S101: generating a plurality of planned routes and sending the planned routes to a passenger side for selection, and generating route planning information at the passenger side, and receiving the route planning information returned from the passenger side; or

S102: generating an optimal planned route, sending the optimal planned route to the passenger side for confirmation or modification, and generation of route planning information and receiving the route planning information returned from the passenger side.

The driving behavior information collected at step S10 further includes a driving route.

Step S30 further includes:

S301: performing a route assessment according to the route planning information and the driving route.

Step S101 allows the user's operation mode to be simpler, and step S102 allows the user operation to have a higher degree of freedom. In another embodiment, step S101 and step S102 may adopt a fusion manner, that is, a route editing function is provided while multiple options are provided for the user. In further embodiments, the mode of determining the route by the driver or automatically by the system may also be configured according to different actual needs.

Optionally, the driver side and the passenger side may also synchronously display the planned route and estimated time thereof, and perform a navigation.

In step S301, by comparing the planned route with an actual driving route, it may be determined whether there is a poor driving behavior of detour, and in this embodiment, in the case where a predetermined mileage is exceeded by a threshold value, and the score is deducted according to a preconfigured rule.

Optionally, for a route that the passenger and the driver negotiate to change during the driving, the passenger side may submit a route change request, and the driver side confirms the route change request after receiving the route change request.

The embodiment further provides the right of route planning for the passenger, and performs a route assessment according to the planned route and the actual driving route, so that the objective evaluation of the driving service is realized, while the convenience is provided for the passenger and rights and interests of the passenger are guaranteed.

As shown in FIG. 5, in this embodiment, the method further includes:

S401: collecting monitoring information.

Step S70 further includes:

S701: assessing the monitoring information according to a preconfigured service assessment rule.

Specifically, for the monitoring information collected in step S401, in step S701, sound of the passenger and sound of the driver may be distinguished from each other through a pre-recorded voiceprint information of the driver, so as to detect whether the driver has an overstimulated language (words and topics that the driver is forbidden from talking or speaking may be preset), and also record whether the driver answer a reasonable requirement for the passenger correctly or politely to and meet the requirement, such as inquiring a temperature in the vehicle, favorite music or radio station, and the like, so as to improve a vehicle-using experience of the passenger, thereby restricting and improving a service quality and attitude of the driver. In a case where the driver does not meet the reasonable requirement of the passenger, the score is deducted according to a preconfigured rule. In a case where the driver has an improper or overstimulated language, loud noise and the like, the score is deducted according to a preconfigured rule.

The above embodiment further performs an assessment for service attitude and quality by collecting the monitoring information, which further improves the objectivity of the assessment for services, and further provides an objective basis for disputes.

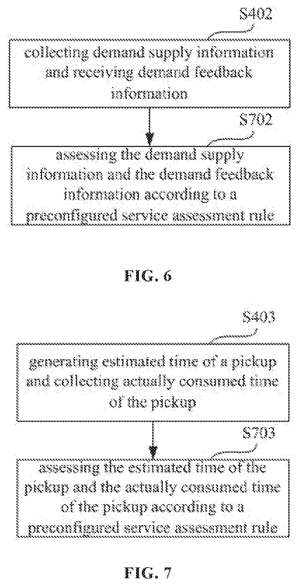

As shown in FIG. 6, in this embodiment, the method further includes:

S402: collecting demand supply information and receiving demand feedback information.

Step S70 further includes:

S702: assessing the demand supply information and the demand feedback information according to a preconfigured service assessment rule.

Specifically, the demand supply information refers to the relevant information for supplying the demand, which is input or collected after the driver side receives the demand information from the passenger side; the demand feedback information refers to feedback information input by the passenger side according to whether the driver supplies the demand.

For example, the passenger side has reserved special requirement service options when reserving driving service, so that the driver may prepare in advance, for example, “need paper towel”, “need bottled water”, “need android charger”, etc., and may also input other special requirements by himself, for example, “not turn on air conditioner”, “not listen to radio”, etc. After receiving the demand information at the driver side, a driver may be informed through voice playing so that the driver may know the demand of the passenger, and after the driver meets the demand of the passenger, at the driver side, the demand supply information may be input through a “met” button corresponding to the demand, and the demand supply information may be further collected in modes of collecting images of paper towels prepared for the passenger and the like; when the driver meets the demand or does not meet the demand, the passenger may input demand feedback information through a “met” or “not met” button corresponding to the demand at the passenger side, so that the passenger side may send the demand feedback information to the driver side for scoring.

In step S702, it is determined comprehensively according to the information provided by the driver side and the passenger side, respectively, whether the driver meets the requirements of the passenger, and if not, the score is deducted according to a preconfigured rule.

The above embodiment further collects the demand supply information through the driver side and receives the demand feedback information sent by the passenger side, so that the objectivity of demand service assessment is improved, and the rights and interests of the driver and the passenger are guaranteed.

As shown in FIG. 7, in this embodiment, the method further includes:

S403: generating estimated time of a pickup and collecting actually consumed time of the pickup.

Step S70 further includes:

S703: assessing the estimated time of the pickup and the actually consumed time of the pickup according to a preconfigured service assessment rule.

Specifically, the estimated time for the pickup may be assessed and generated according to the mileage of the planned route for the pickup, traffic lights, road conditions (whether congestion exists) and other information, and the actually consumed time for the pickup is acquired by timing. And when the actually consumed time for the pickup exceeds the estimated time for the pickup by a preset threshold value, the score is deducted according to a preconfigured rule. For example, if the preset threshold value is 3 minutes, 1 is deducted, if the preset threshold value is 5 minutes, 3 is deducted, etc.

The above embodiment further performs the efficiency assessment for the pickup according to the estimated time and the actually consumed time for the pickup, thereby realizes the objective assessment of the efficiency for the pickup, and further realizes a more comprehensive and objective assessment for driving service.

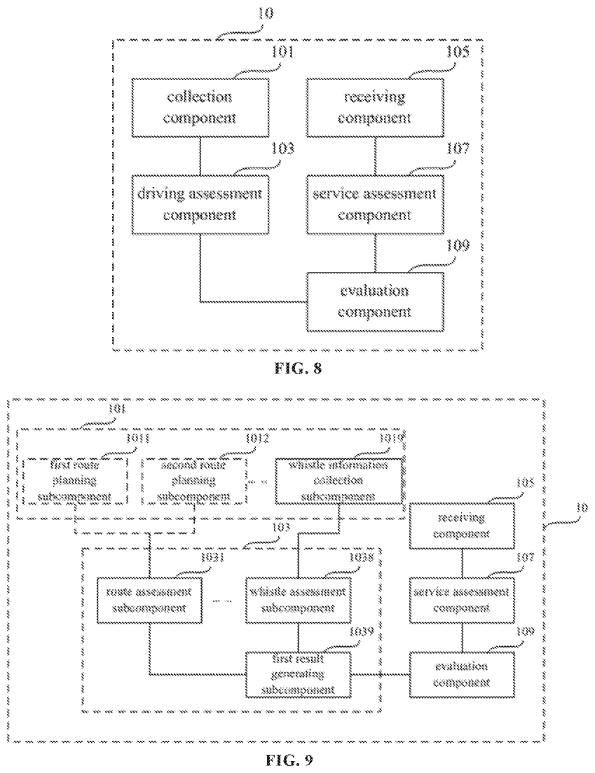

FIG. 8 is a schematic structural diagram of an evaluation device for driving service according to an embodiment of the present disclosure. The device shown in FIG. 8 may be configured to perform the method shown in FIG. 1 or 3.

As shown in FIG. 8, in the present embodiment, the evaluation device for driving service 10 includes a collection component 101, a driving assessment component 103, a receiving component 105, a service assessment component 107, and an evaluation component 109. The receiving component 105 and the service assessment component 107 are optional.

The collection component 101 is configured to collect driving behavior information and travel information;

The driving assessment component 103 is configured to assess the driving behavior information and the travel information according to a preconfigured driving assessment rule to obtain a driving assessment result;

The receiving component 105 is configured to receive passenger evaluation information;

The service assessment component 107 is configured to assess the passenger evaluation information according to a preconfigured service assessment rule to obtain a service assessment result;

The evaluation component 109 is configured to generate an evaluation result according to the driving assessment result; or generate an evaluation result according to the driving assessment result and the service assessment result.

In the present embodiment, the driving assessment component 103, the service assessment component 107, and the evaluation component 109 are configured as a processor; the receiving component 105 is configured as a communication component for receiving passenger evaluation information sent from a passenger side through communication with a remote server terminal; the collection component 101 is configured as a set of an information collection component (e.g., a voice collection component, an image collection component, etc.), a communication component and a processor, and performs direct collection of information through the information collection component, performs the collection through communication with an on-vehicle system, a remote server and the internet, and performs data analysis on collected information through the processor to complete the collection. In further embodiments, the various components described above may also be configured in different combinations as would be understood by one of ordinary skill in the art.

Optionally, the driving behavior information includes at least one of: a vehicle speed on each road section of the travel, an acceleration on each road section of the travel, the number of times of lane change, a frequency of lane change, the number of times of whistle, a frequency of whistle; the travel information includes at least one of: speed limit information on each road section of the travel, road condition congestion information on each road section of the travel, place information of prompting deceleration, curve section information and the like.

Optionally, the collection component 101 further includes a mark subcomponent (sub-unit) configured to record a travel speed curve and perform marking of key positions on the travel speed curve, so as to assess driving behaviors of each key position. Here, the key positions specifically include at least one of: intersections, traffic lights, sharp turns, consecutive curves, train tracks, pedestrian paths, tunnels, low-speed-limit sections, mountain roads, accident-prone sections, villages, front schools.

The evaluation principle for driving service of the device shown in FIG. 8 may refer to the method shown in FIGS. 1-3, and the details are not repeated here.

As shown in FIG. 9, in the present embodiment, the travel information includes route planning information, and the driving behavior information includes a driving route.

The collection component 101 includes a first route planning subcomponent 1011 or a second route planning subcomponent 1012. The first route planning subcomponent 1011 is configured to generate a plurality of planned routes and send the planned routes to the passenger side for selection and generation of route planning information, and receive route planning information returned from the passenger side. The second route planning subcomponent 1012 is configured to generate an optimal planned route, send the optimal planned route to a passenger side for confirmation or modification, and generation of route planning information, and receiving the route planning information returned from the passenger side.

The driving assessment component 103 includes a route assessment subcomponent 1031 configured to perform an assessment based on the route planning information and the driving route.

The evaluation principle for driving service of the device shown in FIG. 9 may refer to the method shown in FIG. 4, and the details are not repeated here.

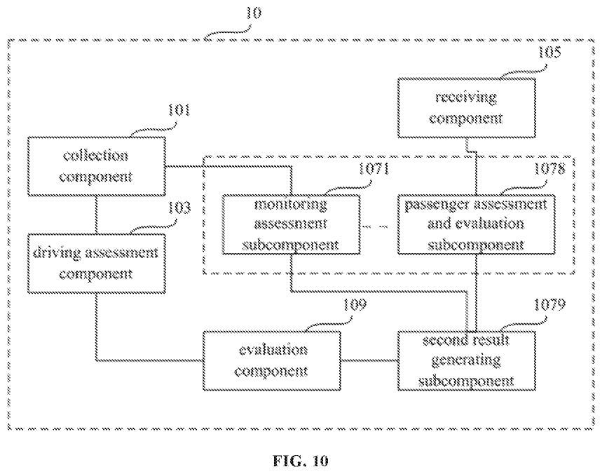

FIG. 10 is a schematic structural diagram of an embodiment of an evaluation device for driving service according to another preferred embodiment of the device shown in FIG. 8. The device shown in FIG. 10 may be configured to perform the method shown in FIG. 5 accordingly.

As shown in FIG. 10, in this embodiment, the collection component 101 further includes a monitoring subcomponent. The listening subcomponent is configured to collect monitoring information.

The service assessment component 70 also includes a monitoring assessment subcomponent 701. The monitoring assessment subcomponent 701 is configured to perform an assessment for the monitoring information in accordance with a preconfigured service assessment rule.

The evaluation principle for driving service of the device shown in FIG. 10 may refer to the method shown in FIG. 5, and the details are not repeated here.

In an exemplary embodiment, the collection component 101 is further configured to collect demand supply information and the receiving component 105 is further configured to receive demand feedback information. The service assessment component 70 also includes a demand assessment subcomponent configured to assess demand supply information and demand feedback information according to a preconfigured service assessment rule. The evaluation principle for driving service of the device provided by the exemplary embodiment may refer to the method shown in FIG. 5, and the details are not repeated here.

In an exemplary embodiment, the above device further includes an estimation component configured to generate estimated time for a pickup; the collection component 101 is further configured to collect actually consumed time of the pickup. The service assessment component 70 further includes a pickup assessment subcomponent configured to assess the estimated time for a pickup and the actually consumed time of the pickup according to a preconfigured service assessment rule. The evaluation principle for driving service of the device provided by the exemplary embodiment may refer to the method shown in FIG. 6, and the details are not repeated here.

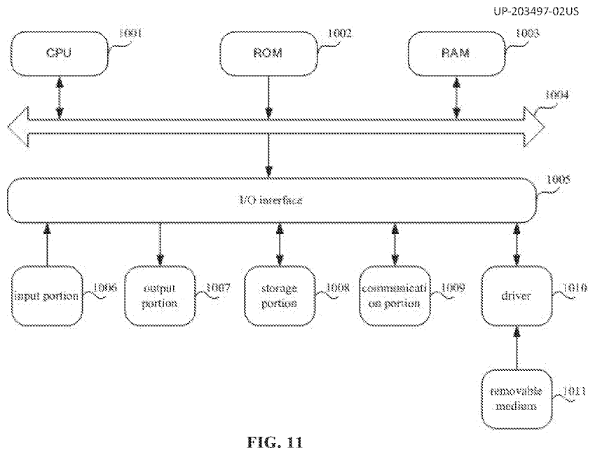

FIG. 11 is a schematic structural diagram of an apparatus according to an embodiment of the present disclosure.

As shown in FIG. 11, as another aspect, an embodiment of the present disclosure also provides an electronic apparatus 1000 including one or more central processing units (CPU) 1001 that may perform various appropriate actions and processes according to a program stored in a Read Only Memory (ROM) 1002 or a program loaded from a storage portion 1008 into a Random Access Memory (RAM) 1003. In the RAM 1003, various programs and data necessary for the operation of the apparatus 1000 are also stored. The CPU 1001, ROM 1002, and RAM 1003 are connected to each other by a bus 1004. An input/output (I/O) interface 1005 is also connected to the bus 1004.

The following components are connected to the I/O interface 1005: an input portion 1006 including a keyboard, a mouse, and the like; an output portion 1007 including a display such as a Cathode Ray Tube (CRT), a Liquid Crystal Display (LCD), and the like, and a speaker; the storage portion 1008 including a hard disk and the like; and a communication portion 1009 including a network interface card such as a LAN card, a modem, or the like. The communication portion 1009 performs communication processing via a network such as the internet. A driver 1010 is also connected to the I/O interface 1005 as necessary. The removable medium 1011, such as a magnetic disk, an optical disk, a magneto-optical disk, a semiconductor memory, or the like, is mounted on the driver 1010 as necessary, so that a computer program read out therefrom is mounted into the storage portion 1008 as necessary.

In particular, according to an embodiment of the present disclosure, the evaluation method for driving service described in any of the above embodiments may be implemented as a computer software program. For example, embodiments of the present disclosure include a computer program product including a computer program tangibly embodied on a machine-readable medium, and the computer program includes program codes for performing the evaluation method for driving service. In such an embodiment, the computer program may be downloaded and installed from the network through the communication portion 1009 and/or installed from the removable medium 1011.

As yet another aspect, an embodiment of the present disclosure also provides a computer-readable storage medium, which may be the computer-readable storage medium included in the device of the above embodiment; or it may be a separate computer readable storage medium not incorporated into the apparatus. The computer-readable storage medium stores one or more programs for use by one or more processors in performing the evaluation method for driving service described in the present disclosure.

The flowchart and block diagrams in the drawings illustrate architecture, functionality, and operation possibly implemented by systems, methods and computer program products according to various embodiments of the present disclosure. In this regard, each block in the flowchart or block diagrams may represent a module, segment, or portion of code, which includes one or more executable instructions for implementing the specified logical function. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart and a combination of blocks in the block diagrams and/or flowchart may be implemented by special purpose hardware-based systems that perform the specified functions or operations, or a combination of special purpose hardware and computer instructions.

The components or modules described in the embodiments of the present disclosure may be implemented by software or hardware. The described components or modules may also be provided in a processor, for example, each of the described components may be a software program provided in a computer or a mobile intelligent apparatus, or may be a separately configured hardware device. The designation of such components or modules does not constitute a limitation on the component or module itself in some case.

The foregoing description is only the preferred embodiments of the present disclosure and is illustrative of the principles of the technology employed. It will be appreciated by one of ordinary skill in the art that the scope of the present disclosure herein is not limited to the particular combination of features described above, but also encompasses other technical solutions formed by any combination of features described above or their equivalents without departing from the spirit of the present disclosure. For example, the above features and the technical features disclosed in the present disclosure (but not limited to) having similar functions are replaced with each other to form the other technical solution.

1. An evaluation method for driving service, comprising steps of:
collecting driving behavior information and travel information;
assessing the driving behavior information and the travel information according to a preconfigured driving assessment rule to obtain a driving assessment result; and
generating an evaluation result according to the driving assessment result.

2. The evaluation method of claim 1, wherein the step of collecting driving behavior information and travel information comprises a step of:
recording a travel speed curve, and marking key positions on the travel speed curve to assess a driving behavior of each of the key positions.

3. The evaluation method of claim 1, wherein,
the step of assessing the driving behavior information and the travel information according to the preconfigured driving assessment rule to obtain a driving assessment result further comprises a step of:
performing an assessment for a route according to route planning information and a driving route.

4. The evaluation method of claim 3, wherein the step of collecting driving behavior information and travel information further comprises at least one of steps of:
generating a plurality of planned routes and sending the plurality of planned routes to a passenger side for selection and generation of route planning information, and receiving the route planning information returned from the passenger side; and
generating an optimal planned route, sending the optimal planned route to the passenger side for confirmation or modification and generation of route planning information, and receiving the route planning information returned from the passenger side.

5. The evaluation method of claim 1, further comprising steps of:
receiving passenger evaluation information;
assessing the passenger evaluation information according to a preconfigured service assessment rule to obtain a service assessment result;
wherein the step of generating an evaluation result according to the driving assessment result comprises a step of: generating the evaluation result according to the driving assessment result and the service assessment result.

6. The evaluation method of claim 5, further comprising collecting monitoring information;
wherein the step of assessing the passenger evaluation information according to a preconfigured service assessment rule to obtain a service assessment result further comprises a step of:
performing an assessment for service attitude and quality according to the monitoring information and a preconfigured service assessment rule.

7. The evaluation method of claim 5, further comprising: collecting demand supply information and receiving demand feedback information;
wherein the step of assessing the passenger evaluation information according to a preconfigured service assessment rule to obtain a service assessment result further comprises a step of:
assessing the demand supply information and the demand feedback information according to a preconfigured service assessment rule.

8. The evaluation method of claim 5, further comprising generating estimated time of a pickup and collecting actually consumed time of the pickup;
wherein the step of assessing the passenger evaluation information according to a preconfigured service assessment rule to obtain a service assessment result further comprises a step of:
assessing the estimated time of the pickup and the actually consumed time of the pickup according to a preconfigured service assessment rule.

9. The evaluation method of claim 1, wherein the driving behavior information comprises at least one of: a vehicle speed on each road section of a travel, an acceleration on each road section of the travel, the number of lane changes, a frequency of lane changes, the number of whistles, a frequency of whistles;
the travel information comprises at least one of: speed limit information on each road section of the travel, road condition congestion information on each road section of the travel, place information of prompting deceleration, and curve section information.

10. An evaluation device for driving service, comprising:
a collection component, configured to collect driving behavior information and travel information;
a driving assessment component, configured to assess the driving behavior information and the travel information according to a preconfigured driving assessment rule to obtain a driving assessment result;
an evaluation component configured to generate an evaluation result according to the driving assessment result.

11. The evaluation device of claim 10, wherein the driving behavior information comprises at least one of: a vehicle speed on each road section of a travel, an acceleration on each road section of the travel, the number of lane changes, a frequency of lane changes, the number of whistles, a frequency of whistles;
the travel information comprises at least one of: speed limit information on each road section of the travel, road condition congestion information on each road section of the travel, place information of prompting deceleration, and curve section information.

12. The evaluation device of claim 10, wherein the collection component comprises:
a marking subcomponent, configured to record a travel speed curve and perform marking key positions on the travel speed curve, to assess a driving behavior of each of the key positions.

13. The evaluation device of claim 10, wherein the driving assessment component comprises a route assessment subcomponent, configured to perform a route assessment based on the route planning information and a driving route;
the collection component comprises at least one of a first route planning subcomponent and a second route planning subcomponent;
the first route planning subcomponent is configured to generate a plurality of planned routes, send the plurality of planned routes to a passenger side for selection and generation of route planning information, and receive the route planning information returned from the passenger side; and
the second route planning subcomponent is configured to generate an optimal planned route, send the optimal planned route to a passenger side for confirmation or modification and generation of route planning information, and receive the route planning information returned from the passenger side.

14. An electronic apparatus, comprising:
one or more processors;
a memory for storing one or more programs,
wherein the one or more programs, when executed by the one or more processors, cause the one or more processors to perform the method of claim 1.

15. A non-transitory computer-readable storage medium, storing computer programs which, when executed by a processor, cause the processor to perform the method of claim 1.

16. The evaluation method of claim 2, further comprising steps of:
receiving passenger evaluation information;
assessing the passenger evaluation information according to a preconfigured service assessment rule to obtain a service assessment result;
wherein the step of generating an evaluation result according to the driving assessment result comprises a step of: generating the evaluation result according to the driving assessment result and the service assessment result.

17. The evaluation method of claim 3, further comprising steps of:
receiving passenger evaluation information;
assessing the passenger evaluation information according to a preconfigured service assessment rule to obtain a service assessment result;
wherein the step of generating an evaluation result according to the driving assessment result comprises a step of: generating the evaluation result according to the driving assessment result and the service assessment result.

18. The evaluation method of claim 4, further comprising steps of:
receiving passenger evaluation information;
assessing the passenger evaluation information according to a preconfigured service assessment rule to obtain a service assessment result;
wherein the step of generating an evaluation result according to the driving assessment result comprises a step of: generating the evaluation result according to the driving assessment result and the service assessment result.

19. The evaluation method of claim 18, further comprising collecting monitoring information;
wherein the step of assessing the passenger evaluation information according to a preconfigured service assessment rule to obtain a service assessment result further comprises a step of:
performing an assessment for service attitude and quality according to the monitoring information and a preconfigured service assessment rule.

20. The evaluation method of claim 18, further comprising: collecting demand supply information and receiving demand feedback information;
wherein the step of assessing the passenger evaluation information according to a preconfigured service assessment rule to obtain a service assessment result further comprises a step of:
assessing the demand supply information and the demand feedback information according to a preconfigured service assessment rule.
